(19) United States
(12) Patent Application Publication
(10) Pub. No.: US 2010/0293117 A1
(43) Pub. Date: Nov. 18, 2010

(54) METHOD AND SYSTEM FOR FACILITATING BATCH MODE ACTIVE LEARNING

(76) Inventor: Zuobing Xu, San Jose, CA (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/773,348

(22) Filed: May 4, 2010

Related U.S. Application Data
(60) Provisional application No. 61/177,302, filed on May 12, 2009.

(51) Int. Cl. G06F 15/18; G06N 5/02

(52) U.S. Cl. 706/12; 706/52

(57) ABSTRACT

A method and system for performing batch mode active learning to train a classifier. According to embodiments of the present invention, unlabeled documents are selected from a corpus based on rewards associated with each unlabeled document. The reward is an indication of the increase to the accuracy of a classifier which may result if the document is used to train the classifier. When calculating a given reward, embodiments of the present invention address the uncertainty and diversity of a given document. Embodiments of the present invention reduce the resources utilized to perform classifier training.

### CROSS-REFERENCE TO RELATED APPLICATION

This application claims the benefit of U.S. Provisional Patent Application No. 61/177,302, filed May 12, 2009, titled “An Efficient Batch Mode Active Learning Algorithm,” which is herein incorporated by reference.

### FIELD OF THE INVENTION

The present invention relates generally to classifier training. More specifically, embodiments of the present invention relate to a method and system for creating batches of documents used to train classifiers.

### BACKGROUND OF THE INVENTION

Effective large scale data classification plays an increasingly important role in enterprise information management systems. One example of an enterprise information system is an e-discovery application that applies a classifier to find relevant documents within large enterprise document repositories, for different legal purposes, such as litigation, investigation, and retention. These systems often rely on human or humans to manually label documents. For example, a human may be required to read an entire document to label the document as relevant/non-relevant, confidential, or any other desired classification. In order to optimize utilize the effort of human labeling involved in data classification, active learning has been implemented to assist in selecting the data to be labeled. Effective active learning algorithms often reduce the human labeling effort, as well as produce more efficient data classifiers.

In many practical domains, active learning is a reasonable approach since the cost of human labeling becomes a major concern when attending to a document request. For instance, when implemented in relation to an e-discovery request, a classification system interacts with a user (e.g., a lead attorney) to define the relevance scope and criterion of the e-discovery request, by actively presenting exemplar documents to the user. An exemplar document may reflective of the type of document which is responsive to a given document request and can be used as a guide or template to train a classifier. Given the tremendous increase in the size of files that are reviewed during e-discovery, for example, in some cased millions to billions of files, there is a desire to reduce the number of exemplar documents reviewed by the user while still providing the classification system with an adequate sample set of labeled documents to effectively train the data classifier.

Conventional methods of performing active learning have focused on pool-based active learning. In pool based active learning, the active learner, or classification system, is presented with a pool of unlabeled data. The active learner applies a query function to select a single exemplar and acquire its label. Then the classifier is retrained with the newly labeled datum. The active learner continues the above process until a stopping criterion (e.g., a given number of documents have been reviewed) is satisfied. Conventional pool-based active learning is not efficient because the classifier needs to be retrained after labeling each example, leading to inefficiencies caused by training a classified based on a single document.

In addition to the time consuming process of training a classifier based on each new datum, conventional active learning methods also have difficulty training classifiers because of their reliance on a greedy algorithm to select a document from a corpus, wherein a corpus is a collection of documents to be reviewed. When selecting a document for training purposes, a greedy algorithm primarily addresses prospective factors and fails to consider the impact of previous decisions on the selection process. For example, given a set of three documents including document A, document B and document C, the greedy algorithm may determine that document B would provide the greatest benefit when training a classifier at the present time, in comparison to the other two documents. The benefit to the classifier may be defined by the greatest incremental increase to the accuracy of the classifier. However, when comparing the benefit of document B with previously selected documents, document B may not provide the greatest benefit as between the three documents. Therefore, a greedy algorithm often fails at determining the most beneficial selection at a given point in time because the greedy algorithm does not consider pervious decisions when making a present decision.

As a result, there is a need in the art for a method and system to more effectively select documents for use in classifier training.

### SUMMARY OF THE INVENTION

Embodiments of the present invention satisfy these needs and others by providing a method and system for training a classifier based on a batch of labeled documents (herein referred to as “batch mode active learning”). In order for a classifier to correctly identify an unlabeled document, the classifier must be trained through the use of a plurality of labeled documents. As used herein “document” may include, but is not limited to, a text file, image file or another data structure that may be identified by a classifier. As a result of training a classifier based on a batch of labeled documents, the classifier is configured to more accurately identify unlabeled documents. There term “unlabeled document” is intended to include, but is not limited to, a document, or other data element, wherein the document type has yet to be determined, such as, for example, relevant, confidential, privileged, or for attorneys' eyes only. For example, in the context of a document review in response to a request for production in a litigation, an unlabeled document may be any document that has yet to be identified as relevant or non-relevant. Each document used to train a classifier may have an incremental effect on the accuracy of the classifier.

According to an embodiment of the present invention, batch mode active learning includes a step of labeling a batch of unlabeled documents as well as training a classifier based on the batch once the documents have been labeled. Both of these steps may be time and resource intensive depending on the number and length of the unlabeled documents utilized. To minimize the number of documents used to perform batch mode active learning, embodiments of the present invention intelligently select the unlabeled documents to include in a batch of unlabeled documents based on a reward associated with a given unlabeled document. The term “reward” is intended to include, but is not limited to, an indication of the incremental increase to the accuracy of a classifier which may result if the document is used to train the classifier. A reward may be based on the uncertainty and diversity associated with each document. By including the document with the greatest reward in a batch, the number of documents and the number of batches used to train a classifier may be minimized.

According to certain embodiments of the present invention, a batch of unlabeled documents may be formed by selecting an unlabeled document with the greatest associated reward from a pool of unlabeled documents, or corpus. The reward of the selected document is then updated by recalculating the diversity of the selected document as compared to all other documents included in the batch of unlabeled documents. As discussed in more detail below, the term diversity refers to how different a document is compared to one or more other documents. If the updated reward remains the highest from among the corpus, the selected document is added to the batch of unlabeled documents. However, if the updated reward is no longer the highest reward from among the corpus, the selected document is returned to the corpus and the unlabeled document associated with the highest reward is selected. The process of updating the reward is then repeated with the newly selected document. Unlabeled documents are added to the batch of unlabeled documents until a desired batch size has been reached. According to an embodiment of the present invention, a lazy evaluation algorithm may be implemented to reduce the time expended when selecting documents to include in a batch. Embodiments of the present invention may create a batch of documents on average more than one hundred times faster compared to a greedy algorithm.

According to an embodiment of the present invention, following the creation of the batch of unlabeled documents, the batch may be used to train a classifier. Training the classifier may increase the accuracy of the classifier, however, if the accuracy of the classifier does not meet a desired accuracy following the training, a new batch of unlabeled documents may be created and used to train the classifier. The iterative batch active learning process may be repeated until the accuracy of the classifier meets a desired threshold.

Embodiments of the present invention provide for a computer-implemented method for selecting a batch of unlabeled documents from a plurality of unlabeled documents, calculating a reward associated with each unlabeled document within the plurality of unlabeled documents, receiving a desired batch size for the batch of unlabeled documents, and iteratively including an unlabeled document in the batch of unlabeled documents based on the reward associated with the unlabeled document, until the desired batch size is achieved.

### BRIEF DESCRIPTION OF THE DRAWINGS

The present invention will be more readily understood from the detailed description of exemplary embodiments presented below considered in conjunction with the attached drawings, of which:

FIG. 1 illustrates an exemplary system for facilitating batch mode active learning;

FIG. 2 illustrates an exemplary method for facilitating batch mode active learning; and

FIG. 3 illustrates an alternative exemplary method for creating a batch of documents used to train a classifier.

### DETAILED DESCRIPTION OF THE DRAWINGS

The present invention relates to a method and system for performing batch mode active learning, wherein one or more labeled documents are used to train a classifier. The accuracy of a classifier may increase by exposing the classifier to additional labeled documents. To increase efficiency by minimizing the number of documents used with training a classifier, embodiments of the present invention select documents from a corpus based on the reward associated with each document.

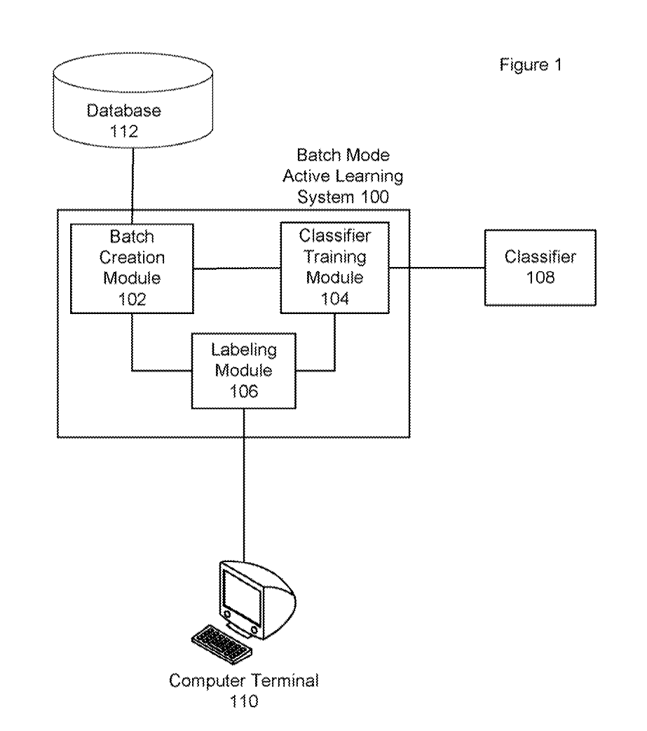

FIG. 1 illustrates a Batch Mode Active Learning System 100 according to an embodiment of the present invention. According to an embodiment of the present invention, as illustrated in FIG. 1, the Batch Mode Active Learning System 100 includes a Batch Mode Creation Module 102, a Classifier Training Module 104, a Labeling Module 106, a Classifier 108, a Labeling Computer Terminal 110, and a Database 112. As used herein, the term “module” is intended to include, but is not limited to, one or more computers configured to execute one or more software programs configured to perform one or more functions. The term “computer” is intended to include any data processing device, such as a desktop computer, a laptop computer, a mainframe computer, a personal digital assistant, a server, a handheld device, or any other device able to process data. The aforementioned components of the Batch Mode Active Learning System 100 represent computer-implemented hardware and/or software modules configured to perform the functions described in detail below. One having ordinary skill in the art will appreciate that the components of the Batch Mode Active Learning System 100 may be implemented on one or more communicatively connected computers. The term “communicatively connected” is intended to include, but is not limited to, any type of connection, whether wired or wireless, in which data may be communicated, including, for example, a connection between devices and/or programs within a single computer or between devices and/or programs on separate computers.

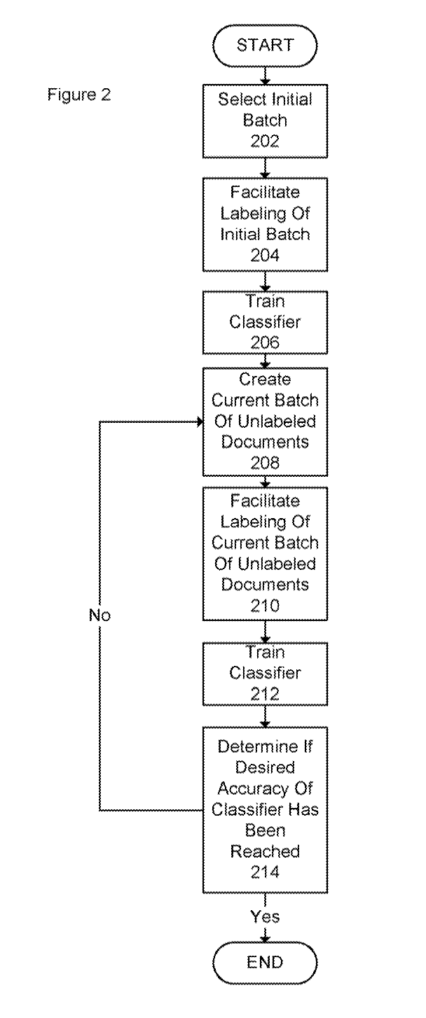

According to the embodiment of the present invention illustrated in FIG. 1 and FIG. 2, the Batch Mode Active Learning System 100 is configured to select, at step 202 of FIG. 2, one or more documents from the Database 112 for use as examples when training the Classifier 108. The Batch Creation Module 102 is configured to create an initial batch of unlabeled documents from the Database 112. The initial batch may be selected randomly from the unlabeled documents stored in the Database 112. The size of the batch may vary based on the given implementation of the present invention. Factors to include when determining the size of the batch may include, but not limited to, the amount of time required to label the documents within the batch, the number of documents within the Database 112, and the desired accuracy of the trained classifier.

Following the creation of the initial batch of unlabeled documents by the Batch Creation Module 102, the unlabeled documents within the initial batch are labeled at step 204 of FIG. 2. The act of labeling an unlabeled document may include, but is not limited to, identifying if the document is relevant or non-relevant, as may be required in response to a discovery request in the context of a litigation. Identification may be performed by a human manually reading each document within the initial batch of unlabeled documents.

The Labeling Module 106 may be configured to communicate with the Computer Terminal 110 to facilitate the labeling of the documents. The Labeling Module 106 may transmit the unlabeled documents to the Computer Terminal 110 for labeling to occur locally on the Labeling Computer Terminal 110. Alternatively, the Computer Terminal 110 may access the unlabeled documents located within the Batch Mode Active Learning System 100, wherein the labeling occurs within the Batch Mode Active Learning System 100.

Following the labeling of the initial batch of unlabeled documents, the Classifier Training Module 104 utilizes the labeled documents within the initial batch to train the Classifier 108, at step 206. According to an embodiment of the present invention, the Classifier 108 may be a Support Vector Machine (SVM), wherein the SVM is trained based on the one or more documents within the initial batch. The SVM is configured to analyze examples and build a model capable of later receiving and labeling one or more unlabeled documents.

According to an embodiment of the present invention, the Classifier 108 has an associated accuracy. The accuracy of the Classifier 108 reflects the likelihood that the Classifier 108 will correctly label an unlabeled document. For example, a Classifier 108 may have an accuracy of 73%, meaning the Classifier 108 is configured to correctly labeled 73% of the unlabeled documents in the document set. The accuracy of a given classifier may be increased by exposing the Classifier 108 to additional labeled documents and therefore retraining the Classifier 108.

The desired accuracy of the Classifier 108 may be selected based on the function for which the Classifier 108 is performing. For example, if the Classifier 108 is implemented to perform an initial review of 1 million documents to determine if a more detailed review should be conducted on the document set, an accuracy of 75% may be acceptable. In contrast, if the Classifier 108 is being used to assist in responding to a discovery request in an active litigation, an accuracy of only 75% may be unacceptable.

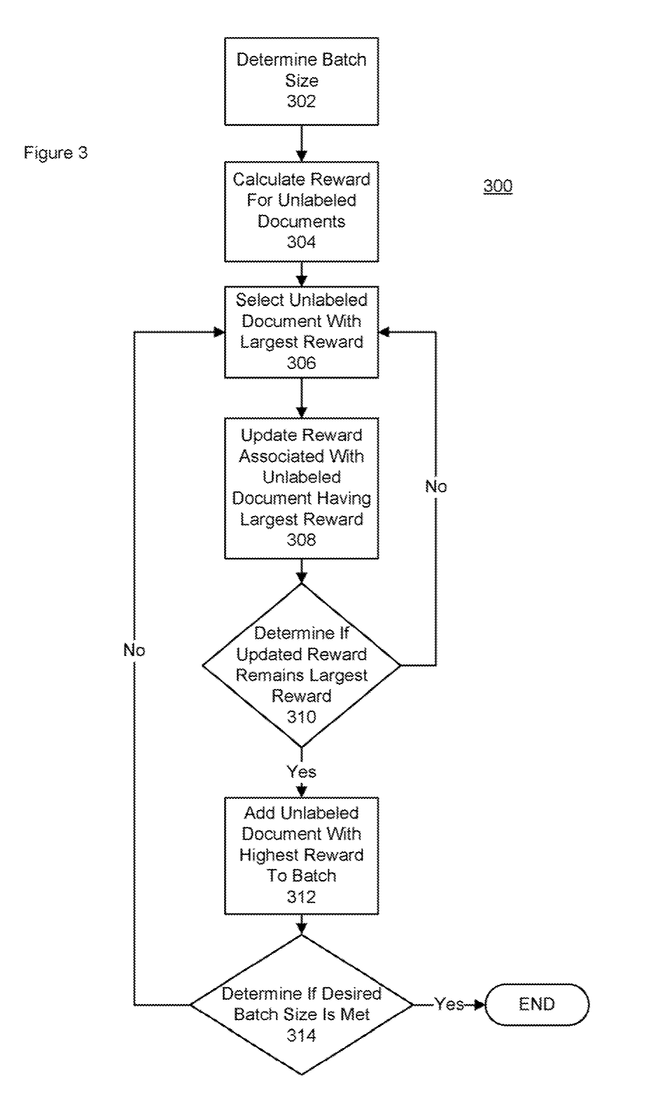

Following the training of the Classifier 108, method 200 continues at step 208 by creating an additional batch of unlabeled documents. Whereas unlabeled document included the initial batch were selected randomly from the corpus, the examples included in the additional batch or batches are selected to include unlabeled documents that provide the greatest increase in accuracy when used to train the Classifier 108. Given that the act of labeling an unlabeled document and training the Classifier 108 based on the unlabeled documents are both time consuming tasks, embodiments of the present invention select documents to maximize the incremental effect that each document may have on the accuracy of the Classifier 108. By selecting unlabeled documents that produce the greatest incremental effect on the accuracy of the Classifier 108, the desired accuracy of the Classifier 108 may be achieved while labeling fewer documents than would be necessary if unlabeled documents where randomly selected from the corpus. The process of selecting one or more unlabeled documents to create an additional batch is described in further detail below in reference FIG. 3.

Process 300, illustrated in FIG. 3, is performed by the Batch Creation Module 102, and comprises the creation of a batch of unlabeled documents from the corpus. When creating a batch of unlabeled documents according to process 300, the aim is to select unlabeled documents that provide the greatest improvement to the accuracy of the Classifier 108 when used to train the Classifier 108. When training the Classifier 108, some documents may provide a greater increase to the accuracy of the Classifier 108 than others. For example, training the Classifier 108 with a document which is only a slight variation of a document that has already been analyzed by the Classifier 108 may not provide as large an increase to the accuracy of the Classifier 108 as would a document that addresses a topic yet to be exposed to the Classifier 108.

According to the embodiment of the present invention illustrated in FIG. 3, method 300 begins at step 302 by selecting a desired batch size. The desired batch size dictates the number of unlabeled documents included in a current batch. The desired batch size may be selected based on the amount of resources available for labeling the unlabeled documents included in the current batch. At the same time, a larger desired batch size may result in a greater increase in the accuracy of the Classifier 108 when the current batch is used as a set of examples. Therefore, the desired batch size may be selected based on a balance between the effectiveness of the batch to increase the accuracy of the Classifier 180 as a set of examples and the resources available to label the unlabeled documents within the batch.

Each unlabeled document within the corpus has an associated reward. A reward is an indication of the increase to the accuracy of the Classifier 108 which may result if the document is used to train the Classifier 108. As a result, the larger the reward, the greater effect the unlabeled document may have on the accuracy of the Classifier 108 if used during classifier training.

According to embodiments of the present invention, the reward for each document is calculated at step 304 of process 300. The reward may be based on the level of uncertainty and diversity associated with each document. To calculate the reward for a given document, the uncertainty and diversity of the document is first calculated.

The uncertainty of a document is a reflection of the likelihood that the Classifier 108 can correctly label the document. Labeling documents with high uncertainties may be beneficial because such documents may significantly improve the classification accuracy, since the Classifier 108 is retrained to fit these uncertain examples. The uncertainty may be measured by different heuristics, including uncertainty sampling in the logistic regression classifier, query by committee in the Naive Bayes classifier, or version space reduction in the support vector machine classifier. The term “version space” is defined as the set of hyperplanes that separate the data in the induced feature space in support vector machine classifiers. According to certain embodiments of the present invention, a margin algorithm may be used to determine an uncertainty, which measures the uncertainty of an unlabeled document by its distance to the current separating hyperplane.

In addition to the uncertainty, a reward is based on the diversity of a document. The diversity of a document is defined as the minimum distance between the unlabeled example and all the selected examples in the batch. A classifier learns less information from a set of similar or redundant data than a set of diversified data. The distance may be calculated as a cosine distance, which is a good distance metric for text data. When documents have yet to be included in a batch the diversity value for all documents within the corpus is zero. At step 304, the uncertainty and diversity of a given document is used to calculate the corresponding reward. The reward function is defined as a linear sum of the uncertainty and diversity interpolated by a tuning parameter. The parameter can be tuned towards more uncertainty or more diversity.

In an alternative embodiment of the present invention, the length of a document may also be factored into the reward associated with the document given that processing a long document may require greater resources than processing a shorter document.

Following the calculating of the reward for the unlabeled documents in the corpus, at step 304 of FIG. 3, the Batch Creation Module 102 selects the unlabeled document from the corpus with the largest reward, at step 306.

To insure that the reward associated with the unlabeled document selected at step 306 remains the greatest among the corpus while factoring in the diversity of the unlabeled document, the reward of the selected unlabeled document is updated at step 308. To update the reward associated with the selected unlabeled document, the diversity between the selected unlabeled document and any unlabeled document already included in the batch is calculated. Despite the fact that the selected unlabeled document may have the highest reward as compared to the unlabeled documents within the corpus, the selected unlabeled document may not be diverse from the unlabeled documents already included in the current batch, and as a result, may not provide a significant increase to the accuracy of the Classifier 108 when used during classifier training. Therefore, the reward associated with the selected unlabeled document is updated by calculating the diversity of the selected unlabeled document compared to each unlabeled document included in the current batch.

Once the reward associated with the selected document has been recalculated at step 308, method 300 continues by determining if the updated reward associated with the selected document remains the largest reward as compared to all of the unlabeled documents within the corpus, at step 310, otherwise referred to as a lazy evaluation algorithm. If the reward associated with the selected unlabeled document decreases as a result of the selected unlabeled document's diversity compared to the unlabeled documents included in the current batch, the selected unlabeled document may no longer have the largest reward compared to the unlabeled document within the corpus. If the reward associated with the selected unlabeled document is found to not be the largest as compared to the unlabeled documents within corpus, the selected unlabeled document is returned to the corpus. By utilizing a lazy evaluation algorithm, the overall computation time is significantly reduced as compared to a greedy algorithm, when the reward is updated only for the unlabeled document that has the highest reward. As a result, in the event that a selected unlabeled document does not have the largest reward, embodiments of the present invention updates the reward associated only the document with the current largest reward instead of updating the reward associated with all unlabeled documents within the corpus. If the selected unlabeled document is returned to the corpus, method 300 returns to step 306 wherein an unlabeled document with the largest associated reward is selected from the corpus. Alternatively, if the reward associated with the unlabeled document remains the largest compared to the corpus, method 300 continues by adding the selected unlabeled document to the current batch, at step 312.

By selecting an unlabeled document based on an associated reward, as well as updating the reward as compared to selections that have already occurred, embodiments of the present invention create a batch differently than would be assembled by a greedy algorithm. Given that a greedy algorithm only addresses the best selection based on prospective factors, and does not include information regarding selections that have already been made, unlabeled documents selected by a greedy algorithm are non-diverse as compared to unlabeled documents that have already been added to a current batch. This lack of diversity decreases the effect the selected unlabeled document has on the accuracy of the Classifier 108. By recalculating the reward of the selected unlabeled document based on its diversity as compared to the unlabeled document(s) included in a batch, embodiments of the present invention compensate for the deficiencies of the greedy algorithm in creating a batch of unlabeled documents that may be used in a batch mode active learning system.

According to the embodiment of the present invention illustrated in FIG. 3, method 300 determines if the desired batch size has been met at step 314. If the current batch contains the desired number of unlabeled documents, method 300 terminates. However, if the current batch does not contain the desired number of unlabeled documents, method 300 returns to step 306 and an additional unlabeled document is selected.

Following the creation of a current batch of unlabeled documents, at step 208, method 200 continues by facilitating the labeling of the current batch of unlabeled documents, at step 210. Labeling of the current batch of unlabeled documents is conducted as described above in reference to step 204. Once the documents within the current batch have been labeled, the Classifier 108 is trained based on the labeled documents within the current batch, at step 212. Advantageously, the Classifier 108 is trained in a consisted manner as described above in reference to step 206.

According to the embodiment of the present invention illustrated in FIG. 2, method 200 continues at step 214 by determining if the desired accuracy of the Classifier 108 has been reached. In order to evaluate the accuracy of the Classifier 108 (e.g. to determine whether to stop training), the Classifier 108 is evaluated on a fully-labeled held-out subset of the corpus. Prior to training the Classifier 108, a portion of the corpus is removed and set aside (i.e., held-out). Holding out the evaluation data prevents the Classifier 108 from being evaluated on documents that the Classifier 108 may later be used to trained the Classifier 108, which can result in “overtraining”, where the Classifier 108 becomes very accurate on the training data but does not generalize to novel data. To determine the accuracy of the Classifier 108, the held-out set must be labeled. The size of the held-out set is selected to allow for labeling of the document without significant expenditure of resources. This is typically feasible because the held-out set is small relative to the entire corpus. Any number of different statistics may be used to summarize accuracy, including the harmonic mean of precision which recalls the proportion of documents the Classifier 108 has identified as true that are actually true and recall is the proportion of all true documents that the Classifier 108 actually identifies as true. Each time accuracy is calculated, the Classifier 108 is tasked with classifying the held-out set.

If the desired accuracy of the Classifier 108 is reached, method 200 terminates. Alternatively, if the desired accuracy of the Classifier 108 is not reached, method 200 returns to step 208 wherein a new batch of unlabeled documents is created. This iterative process is repeated until the desired accuracy for the Classifier 108 is reached.

During each iteration of steps 208 to 214, the size of the current batch may be changed. For example, if the current accuracy of the Classifier 108 is significantly lower than the desired accuracy, the desired batch size for the current batch may be larger to allow for more documents to be included in the current batch, which may result in a large increase in the accuracy of the Classifier 108. However, if the accuracy of the Classifier 108 is only slightly below the desired accuracy, the desired size of the current batch may be smaller in anticipation that only a few documents may be required during classifier training to close the small gap in accuracy.

In an alternative embodiment of the present invention, the iterative process of step 208 to 214 may terminate before the Classifier 108 has reached a desired accuracy. For example, assume the desired accuracy of the Classifier 108 is 94%, and after five iterations of step 208 to 214 the current accuracy of the Classifier 108 is 93.5%. In such an instance when the efforts to increase the accuracy of the Classifier 108 is disproportional to the benefit of increasing the accuracy, method 200 may terminate prior to reaching the desired accuracy. In addition, the desired accuracy may be altered during the performance of method 200 to account for the changes in user's needs and resources. Embodiment of the present invention judge the classifier accuracy based on a test data set to determine if the termination is the best option.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. A computer-implemented method for selecting a batch of unlabeled documents from a plurality of unlabeled documents, comprising:
(a) calculating, by the computer, a reward associated with each unlabeled document within the plurality of unlabeled documents;
(b) receiving, by the computer, a desired batch size for the batch of unlabeled documents; and
(c) iteratively including, by the computer, an unlabeled document in the batch of unlabeled documents based on the reward associated with the unlabeled document, until the desired batch size is achieved.

2. The computer-implemented method of claim 1, further comprising:
(d) receiving, by the computer, a batch of labeled documents based on the batch of unlabeled documents; and
(e) training, by the computer, a classifier based on the batch of labeled documents.

3. The computer-implemented method of claim 2, further comprising:
(f) receiving, by the computer, a desired accuracy for the classifier;
(g) calculating, by the computer, an accuracy of the classifier; and
(h) determining, by the computer, that the accuracy of the classifier meets the desired accuracy.

4. The computer-implemented method of claim 2, further comprising:
(i) receiving, by the computer, a desired accuracy for the classifier;
(j) calculating, by the computer, an accuracy of the classifier;
(k) determining, by the computer, that the accuracy of the classifier does not meet the desired accuracy; and
repeating steps (a) through (e) until the desired accuracy of the classifier is met.

5. The computer-implemented method of claim 1, wherein step (c), comprises:
selecting, by the computer, a first unlabeled document, wherein the reward associated with the first unlabeled document is the highest reward from among the plurality of unlabeled documents,
updating, by the computer, the reward associated with the first unlabeled document based on a diversity between the first unlabeled document and each unlabeled document within the batch of unlabeled documents,
determining, by the computer, that the updated reward associated with the first document remains the highest from among the plurality of unlabeled documents, and
including, by the computer, the first unlabeled document in the batch of unlabeled documents.

6. The computer-implemented method of claim 1, wherein step (c), comprises:
selecting, by the computer, a first unlabeled document, wherein the reward associated with the first unlabeled document is the highest reward from among the plurality of unlabeled documents,
updating, by the computer, the reward associated with the first unlabeled document based on a diversity between the first unlabeled document and each unlabeled document within the batch of unlabeled documents,
determining, by the computer, that the updated reward associated with the first document is not the highest from among the plurality of unlabeled documents,
selecting, by the computer, a second unlabeled document having the highest reward from among the plurality of unlabeled documents,
updating, by the computer, the reward associated with the second unlabeled document based on the diversity between the second unlabeled document and each unlabeled document within the batch of unlabeled documents,
determining, by the computer, that the updated reward associated with the second document remains the highest from among the plurality of unlabeled documents, and
including, by the computer, the second unlabeled document in the batch of unlabeled documents.

7. The computer-implemented method of claim 1, wherein the reward is based on an uncertainty associated with an unlabeled document.

8. The computer-implemented method of claim 1, wherein the reward is based on a length of an unlabeled document.

9. A system for selecting a batch of unlabeled documents from a plurality of unlabeled documents, comprising:
a batch creation module configured to:
(a) calculate a reward associated with each unlabeled document within the plurality of unlabeled documents,
(b) receive a desired batch size for the batch of unlabeled documents; and
(c) iteratively include an unlabeled document in the batch of unlabeled documents based on the reward associated with the unlabeled document, until the desired batch size is achieved.

10. The system of claim 9, further comprising:
a labeling module configured to:
(d) receive a batch of labeled documents based on the batch of unlabeled documents; and
a classifier training module configure to:
(e) train a classifier based on the batch of labeled documents.

11. The systems of claim 9, wherein the classifier training module is further configured to:
(f) receive a desired accuracy for the classifier;
(g) calculate an accuracy of the classifier; and
(h) determine that the accuracy of the classifier meets the desired accuracy.

12. The systems of claim 9, wherein the classifier training module is further configured to:
(i) receive a desired accuracy for the classifier;
(j) calculate an accuracy of the classifier; and
(k) determine that the accuracy of the classifier does not meet the desired accuracy.

13. The system of claim 12, wherein the batch creation module to repeats functions (a) through (c), the labeling module to repeat function (d), and the classifier training module repeats function (e) until the desired accuracy of the classifier is met.

14. The system of claim 9, wherein function (c), comprises:
selecting a first unlabeled document, wherein the reward associated with the first unlabeled document is the highest reward from among the plurality of unlabeled documents,
updating the reward associated with the first unlabeled document based on a diversity between the first unlabeled document and each unlabeled document within the batch of unlabeled documents,
determining that the updated reward associated with the first document remains the highest from among the plurality of unlabeled documents, and
including the first unlabeled document in the batch of unlabeled documents.

15. The system of claim 9, wherein function (c), comprises:
selecting a first unlabeled document, wherein the reward associated with the first unlabeled document is the highest reward from among the plurality of unlabeled documents,
updating the reward associated with the first unlabeled document based on a diversity between the first unlabeled document and each unlabeled document within the batch of unlabeled documents,
determining that the updated reward associated with the first document is not the highest from among the plurality of unlabeled documents, selecting a second unlabeled document having the highest reward from among the plurality of unlabeled documents,
updating the reward associated with the second unlabeled document based on the diversity between the second unlabeled document and each unlabeled document within the batch of unlabeled documents,
determining that the updated reward associated with the second document remains the highest from among the plurality of unlabeled documents, and
including the second unlabeled document in the batch of unlabeled documents.

16. The system of claim 9, wherein the reward is based on an uncertainty associated with an unlabeled document.

17. The system claim 9, wherein the reward is based on a length of an unlabeled document.
